(19) United States
(12) Patent Application Publication
(10) Pub. No.: US 2012/0224276 A1
(43) Pub. Date: Sep. 6, 2012

(54) COLOR FILTER ARRAY AND MANUFACTURING METHOD THEREOF

(75) Inventors: Cheng-Yue Lin, New Taipei City (TW); Shiuan-Fu Lin, New Taipei City (TW); Ching-Yu Yang, Taichung City (TW); Sheng-Kuo Chou, Kaohsiung City (TW); Cheng-Hsien Liao, Taipei City (TW)

(73) Assignee: AU OPTRONICS CORPORATION, Hsinchu (TW)

(21) Appl. No.: 13/244,664

(22) Filed: Sep. 25, 2011

(30) Foreign Application Priority Data
Mar. 1, 2011 (TW) 100106680

(51) Int. Cl. G02B 5/22; B05D 3/00; B05D 5/06

(52) U.S. Cl. 359/891; 427/162

(57) ABSTRACT

A color filter array and a manufacturing method thereof are provided. The color filter array includes a substrate, a light shielding structure and a plurality of color filter patterns. The substrate has a plurality of unit regions. The light shielding structure is disposed on the substrate and has a plurality of openings exposing the unit regions, and at least one sidewall of each of the openings of the light shielding structure has a plurality recess patterns. The color filter patterns are respectively disposed in the openings of the light shielding structure.

### CROSS-REFERENCE TO RELATED APPLICATION

This application claims the priority benefit of Taiwan application serial no. 100106680, filed on Mar. 1, 2011. The entirety of the above-mentioned patent application is hereby incorporated by reference herein and made a part of this specification.

### BACKGROUND OF THE INVENTION

1. Field of the Invention

The present invention relates to a color filter array and a manufacturing method thereof. More particularly, the present invention relates to a color filter array formed with an ink-jet printing process and a manufacturing method thereof.

2. Description of Related Art

Conventionally, a color filter array of a display device is manufactured by a coating process and a photolithography process to form red, green and blue photo resist patterns. However, the coating process wastes a lot of color photo resist material, and the cost of the photolithography process is high. Recently, a new method for forming the color filter array with an ink jet printing process is developed. The ink-jet printing process may simultaneously inject red, green and blue inks into unit regions. Comparing with the conventional process by using the photolithography process, the cost and the manufacturing time of the ink-jet printing process are low.

However, forming the color filter array with the ink-jet printing process has a problem of that the wetting ability of the color inks on a substrate is not enough, and then the adhesion between the color ink and the substrate is affected. When the cohesion of the color ink itself is larger than the adhesion between the color ink and the substrate, the color ink is not evenly or flatly filled in the unit regions. That is, the height of the liquid surface of the color ink at the center of the unit region is higher than the height of the liquid surface of the color ink at the edge of the unit region, such that the height of the whole liquid surface of the color ink is not uniform. As a result, after the color ink is solidified, the formed color filter pattern does not have an even or flat surface, and the non-even or non-flat surface the color filter pattern may deteriorate display quality of a display.

### SUMMARY OF THE INVENTION

Accordingly, the present invention is directed to a color filter array and a manufacturing method thereof capable of resolving the problem of the height of the whole liquid surface of the color ink is not uniform when the color filter array is formed with an ink-jet printing process.

The present invention provides a color filter array includes a substrate, a light shielding structure and a plurality of color filter patterns. The substrate has a plurality of unit regions. The light shielding structure is disposed on the substrate and has a plurality of openings exposing the unit regions, and at least one sidewall of each of the openings of the light shielding structure has a plurality recess patterns. The color filter patterns are respectively disposed in the openings of the light shielding structure.

The present invention provides a method of manufacturing a color filter array. A substrate having a plurality of unit regions is provided. A light shielding structure is formed on the substrate, and the light shielding structure has a plurality of openings exposing the unit regions, wherein at least one side wall of each of the openings of the light shielding structure has a plurality of recess patterns. An ink-jet printing process is performed to inject color inks in the openings of the light shielding structure, wherein the color inks in the openings are drawn into the recess patterns. A curing process is performed to solidify the color inks to form a plurality of color filter patterns.

In light of the foregoing, because the at least one side wall of the openings of the light shielding structure has the recess patterns, the color inks in the openings may be drawn into the recess patterns when the color inks are injected into the openings with the ink-jet printing process. In other words, since the color inks in the openings are drawn into the recess patterns through capillary effect during the ink-jet printing process, the height of the liquid surface of the color ink in each opening of the light shielding structure is uniform. Therefore, after the curing process, the formed color filter patterns may have even or flat surfaces.

In order to make the aforementioned and other features and advantages of the present invention more comprehensible, several embodiments accompanied with figures are described in detail below.

### BRIEF DESCRIPTION OF THE DRAWINGS

The accompanying drawings constituting a part of this specification are incorporated herein to provide a further understanding of the invention. Here, the drawings illustrate embodiments of the invention and, together with the description, serve to explain the principles of the invention.

FIG. 1A to FIG. 1B are schematic diagrams illustrating a method of manufacturing a color filter array according to an embodiment of the invention.

FIG. 2 is a enlarge diagram of the region R shown in FIG. 1A.

FIG. 3A to FIG. 3B are schematic diagrams illustrating a method of manufacturing a color filter array according to another embodiment of the invention.

FIG. 4 is a enlarge diagram of the region R shown in FIG. 3A.

FIG. 5A to FIG. 5B are schematic diagrams illustrating a method of manufacturing a light shielding structure and a light shielding base according to another embodiment of the invention.

FIG. 6A to FIG. 6B are schematic diagrams illustrating a method of manufacturing a color filter array according to another embodiment of the invention.

### DESCRIPTION OF EMBODIMENTS

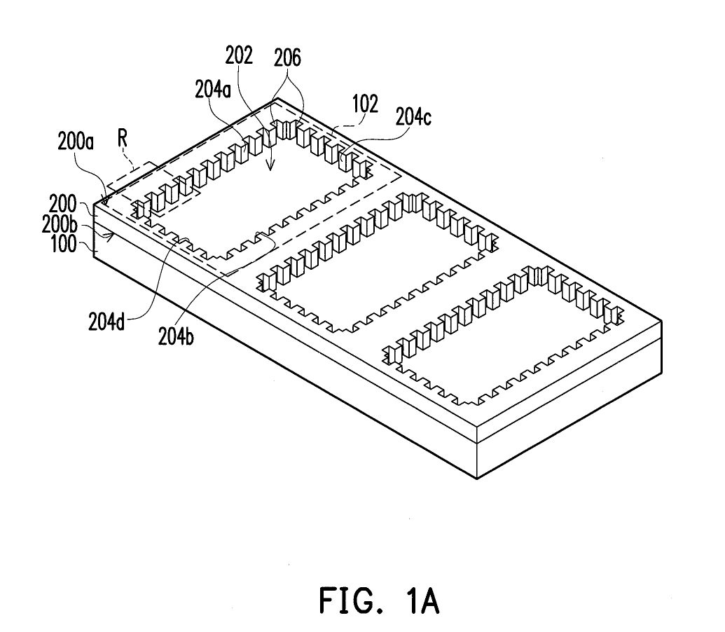

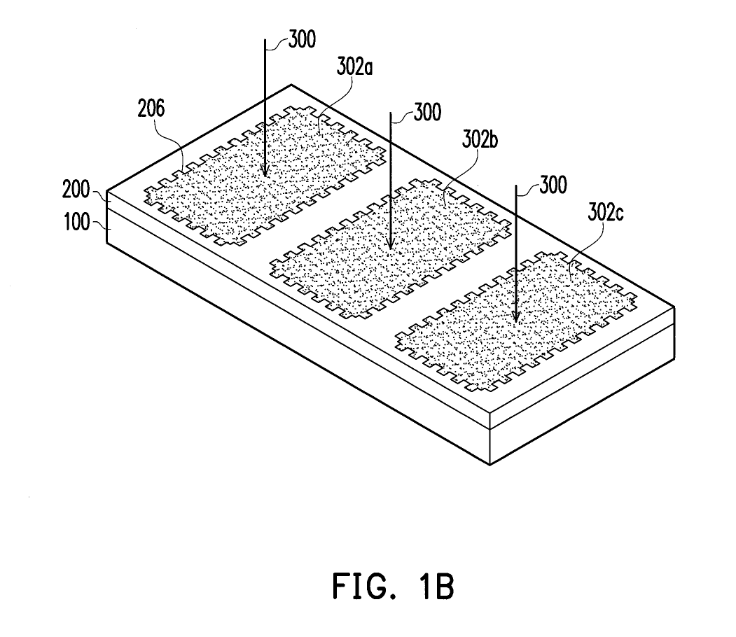

FIG. 1A to FIG. 1B are schematic diagrams illustrating a method of manufacturing a color filter array according to an embodiment of the invention. Referring to FIG. 1A, a substrate 100 having a plurality of unit regions 102 is provided. In order to clearly illustrate the color filter array of the embodiment, three unit regions 102 are shown in the drawings. Actually, the substrate 100 has unit regions 102 more than three, and the unit regions are arranged in an array.

The substrate 100 can be made of glass, quartz, organic polymer, a non-light-transmissive/reflective material (such as a conductive material, metal, wafer, ceramics, or other appropriate materials), or other appropriate materials. In addition, the substrate 100 may be a blank substrate or a substrate having film layers thereon. If the substrate 100 is a blank substrate, the subsequent formed structure is a color filter array substrate. If the substrate 100 is a substrate having film layers thereon, the subsequent formed structure may be a color filter on array (COA) substrate, for example.

A light shielding structure 200 is formed on the substrate 100, and the light shielding structure 200 has a plurality of openings 202 exposing the unit regions 102 of the substrate 100. Similarly, in order to clearly illustrate the color filter array of the embodiment, three openings 202 are shown in the drawings. In the embodiment, the light shielding structure 200 has the openings 202 more than three, and the openings 202 are disposed corresponding to the unit regions 102 of the substrate 100.

According to the embodiment, the light shielding structure 200 is made of a photo sensitive material or a non-photo sensitive material. If the light shielding structure 200 is made of the photo sensitive material, the light shielding structure 200 is formed by a coating process and a curing process to form a light shielding material layer (not shown), and then an exposing process and a developing process are performed to the light shielding material layer so as to form the light shielding structure 200. If the light shielding structure 200 is made of the non-photo sensitive material, the light shielding structure 200 is formed by forming the light shielding material layer (not shown), and then a photolithography process and an etching process are performed to the light shielding material layer so as to form the light shielding structure 200.

In particular, at least one side wall of each of the openings 202 of the light shielding structure 200 has a plurality of recess patterns 206. According to the embodiment, each of the openings 202 of the light shielding structure 200 has a plurality of side walls 204a, 204b, 204c, and 204d, the side walls 204a and 204b are long edge side walls, and the side walls 204c and 204d are short edge side walls, such that the opening 202 is a rectangular opening. However, it is not limited in the present invention. According to another embodiment, the opening 202 may be a square opening, circular opening or other polygon openings.

In the embodiment, all of the side walls 204a, 204b, 204c, and 204d of the opening 202 have recess patterns 206. The recess patterns 206 extend from the side walls 204a, 204b, 204c, and 204d to the inside thereof and do not laterally pass through the light shielding structure 200. Therefore, the adjacent unit regions 102 are separated by the light shielding structure 200, and the adjacent unit regions 102 are not communicated with each other. In addition, the recess patterns 206 are uniformly arranged on the side walls 204a, 204b, 204c, and 204d of the opening 202. The light shielding structure 200 has a top surface 200a and a bottom surface 200b, the bottom surface 200b faces to the substrate 100, and the top surface 200a is opposite to the bottom surface 200b. The recess patterns 206 pass through the light shielding structure 200 from the top surface 200a to the bottom surface 200b, so as to expose the substrate 100.

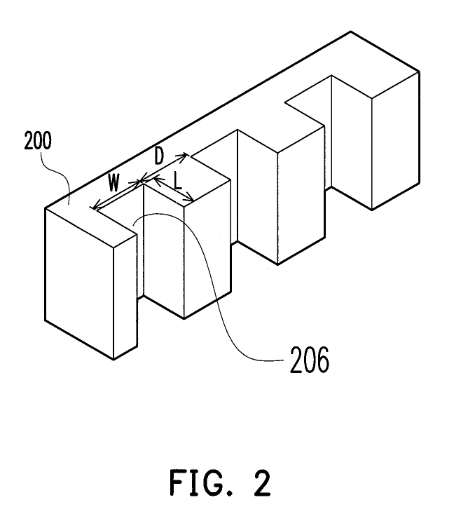

In particular, as shown in FIG. 2 which is a enlarge diagram of the region R shown in FIG. 1A, a width W of the recess patterns 206 is 0<W≦30 um, a length L of the recess patterns 206 is 0<L≦8 um, and a space D between the recess patterns 206 is 0<D≦30 um. Preferably, the width W of the recess patterns 206 is 0<W≦10 um, a length L of the recess patterns 206 is 0<L≦5 um, and a space D between the recess patterns 206 is 0<D≦10 um.

As shown in FIG. 1B, an ink-jet printing process 300 is performed to inject color inks 302a, 302b, 302c into the openings 202 of the light shielding structure 200. In the embodiment, the color inks 302a, 302b, 302c respectively comprise red, green and blue inks, for example. In particular, the color inks 302a, 302b, 302c in the openings 200 are drawn into the recess patterns 206.

It is noted that, the recess patterns 206 are formed on the side walls 204a, 204b, 204c, and 204d of the opening 202 of the light shielding structure 200, and the length and the width of the recess patterns 206 are specifically defined. Hence, the color inks 302a, 302b, 302c may be drawn into the recess patterns 206 through capillary effect of the recess patterns 206 during the ink-jet printing process 300. In other words, the length and the width of the recess patterns 206 should not be defined too large, such that the color inks 302a, 302b, 302c may be drawn into the recess patterns 206 through capillary effect of the recess patterns 206, and thus the color inks 302a, 302b, 302c may be pulled toward the edges of the openings 200. Because the color inks 302a, 302b, 302c may be pulled toward the edges of the openings 200 through the capillary effect of the recess patterns 206, the height of the liquid surface of each color inks 302a, 302b, 302c in the openings 202 is uniform.

According to an embodiment, before performing the ink jet printing process 300, the top surface 200a of the light shielding structure 200 may further be treated to be a lyophobic surface, and the side walls 204a, 204b, 204c, and 204d of the opening 202 of the light shielding structure 200 may further be treated to have lyophilic surfaces. It is beneficial for avoiding each of the color inks 302a, 302b, 302c overflowing to the adjacent openings 202.

After performing the ink jet printing process 300, a curing process is performed to solidify the color inks 302a, 302b, 302c so as to form a plurality of color filter patterns. The curing process is a heating curing process or an illuminating process. Because the height of the liquid surface of each color inks 302a, 302b, 302c in the openings 202 is uniform, the solidified color inks 302a, 302b, 302c (color filter patterns) have even or flat surfaces. If a display having said color filter array, the display may have good color display quality.

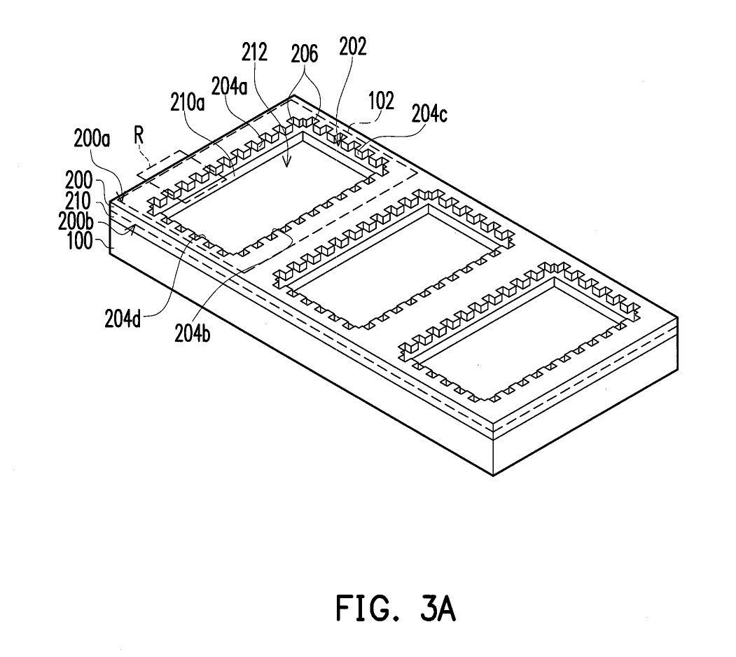

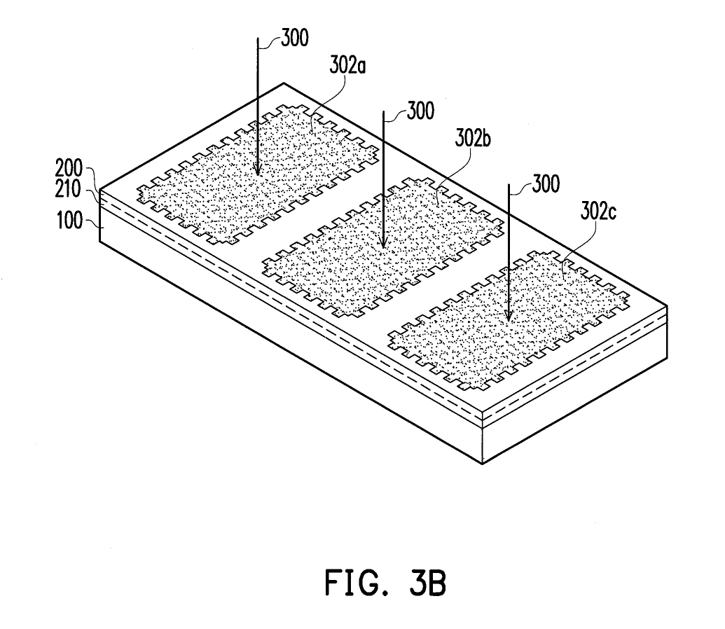

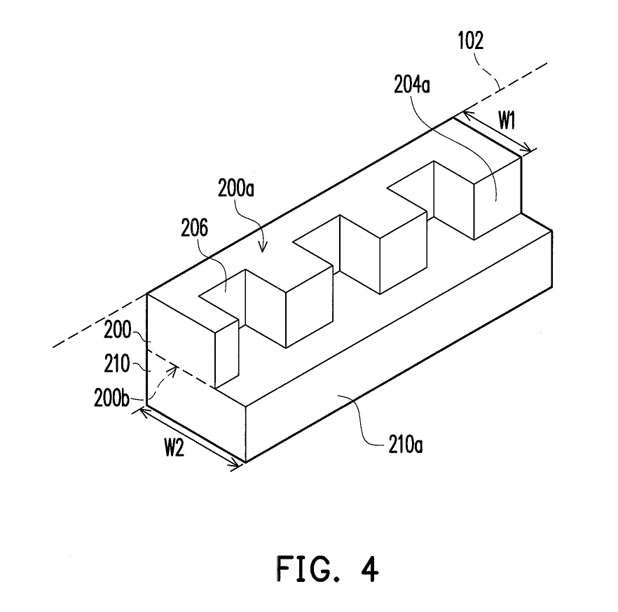

FIG. 3A to FIG. 3B are schematic diagrams illustrating a method of manufacturing a color filter array according to another embodiment of the invention. FIG. 4 is a enlarge diagram of the region R shown in FIG. 3A. The embodiment of FIG. 3A to FIG. 3B is similar to the embodiment of FIG. 1A to FIG. 1B, and components identical to those of FIG. 1A and FIG. 1B will be denoted with the same numerals and not repeated herein. Referring to FIG. 3A, in the embodiment, a light shielding base 210 is further formed on a bottom of the light shielding structure 200, as shown in FIG. 4.

Referring to FIG. 3A and FIG. 4, the light shielding structure 200 has a plurality of openings 202, and the light shielding base 210 has a plurality of openings 212. The openings 202 of the light shielding structure 200 and the openings 212 of the light shielding base 210 are disposed corresponding to the unit region 102 of the substrate 100. Similarly, all of the side walls 204a, 204b, 204c, and 204d of the opening 202 corresponding to the light shielding structure 200 have recess patterns 206, and the length, the width and the space of the recess patterns 206 are the same or similar to the embodiment shown in FIG. 1A (FIG. 2). The light shielding base 210 is formed on the bottom of the light shielding structure 200. The recess patterns 206 expose the light shielding base 210. In other words, the recess patterns 206 passes though the light shielding structure 200 from the top surface 200a to the bottom surface 200b so as to expose the light shielding base 210. In addition, the opening 212 of the light shielding base 210 has a side wall 210a, and a width W2 of the light shielding base 210, which is from the edge of the unit region 102 to the side wall 210a of the opening 212 of the light shielding base 210, is larger than a width W1 of the light shielding structure 200, which is from the edge of the unit region 102 to the side wall 204a of the opening 202 of the light shielding structure 200.

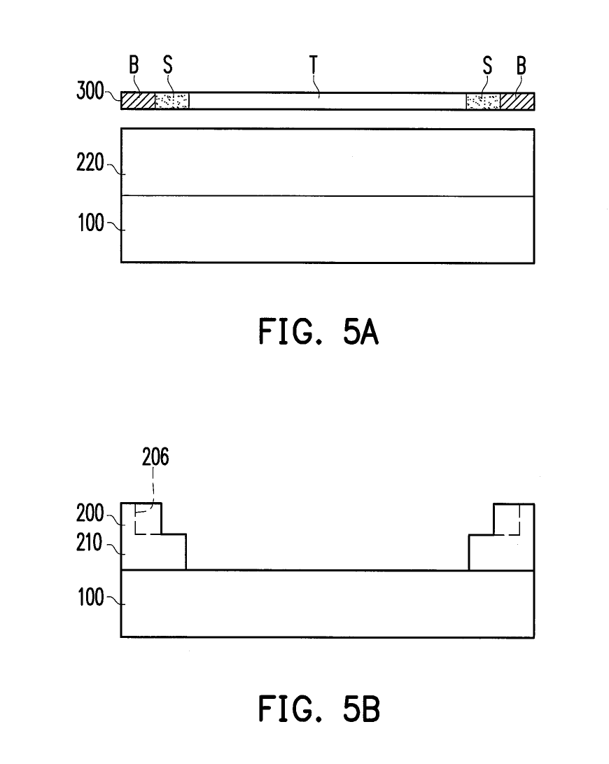

Moreover, the light shielding base 210 and the light shielding structure 200 may be formed by performing a half-tone mask process. FIG. 5A to FIG. 5B are schematic diagrams illustrating a method of manufacturing a light shielding structure and a light shielding base according to another embodiment of the invention. Referring to FIG. 5A, a light shielding material layer 220 is formed on the substrate 100 by performing a coating process and a curing process. A half-tone mask 300 having a transparent region T, a non-transparent region B and a semi-transparent region S is disposed above the light shielding material layer 220. An exposing process is performed to the light shielding material layer 220 with the half-tone mask 300, and then a developing process is performed, so as to pattern the light shielding material layer 220 to form the structure as shown in FIG. 5B. In the structure as shown in FIG. 5B, the patterned light shielding material layer 220 has the light shielding base 210 and the light shielding structure 200, and the light shielding structure 200 has recess patterns 206 therein.

Referring to FIG. 3A, after forming the light shielding base 210 and the light shielding structure 200, an ink-jet printing process 300 is performed to inject color inks 302a, 302b, 302c into the openings 202 of the light shielding structure 200 and the opening 212 of the light shielding base 210, as shown in FIG. 3B. Similarly, because the length and the width of the recess patterns 206 are specifically defined, the color inks 302a, 302b, 302c may be drawn into the recess patterns 206 through capillary effect of the recess pattern 206 during the ink-jet printing process 300. In particular, the color inks 302a, 302b, 302c may be pulled toward the edges of the openings 200 through the capillary effect of the recess patterns 206, and therefore, the height of the liquid surface of each color inks 302a, 302b, 302c in the openings 202 is uniform. Thereafter, a curing process is performed to solidify the color inks 302a, 302b, 302c so as to form a plurality of color filter patterns.

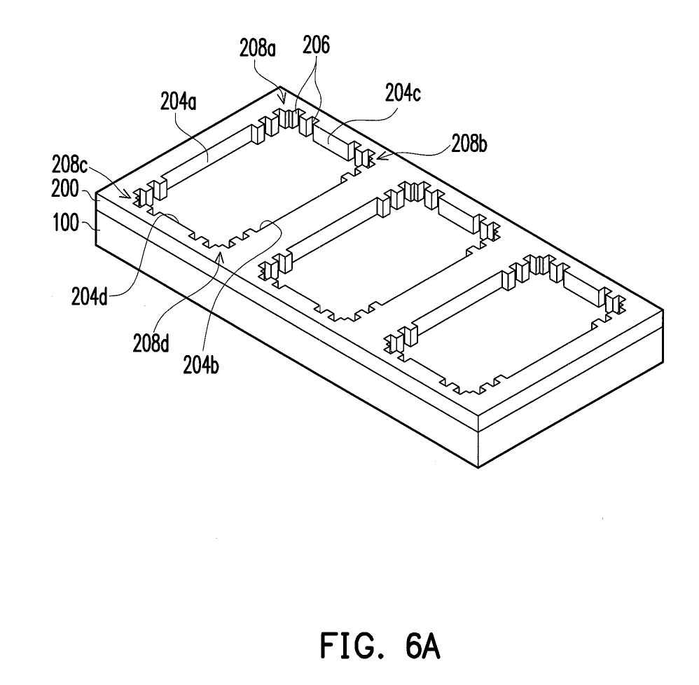

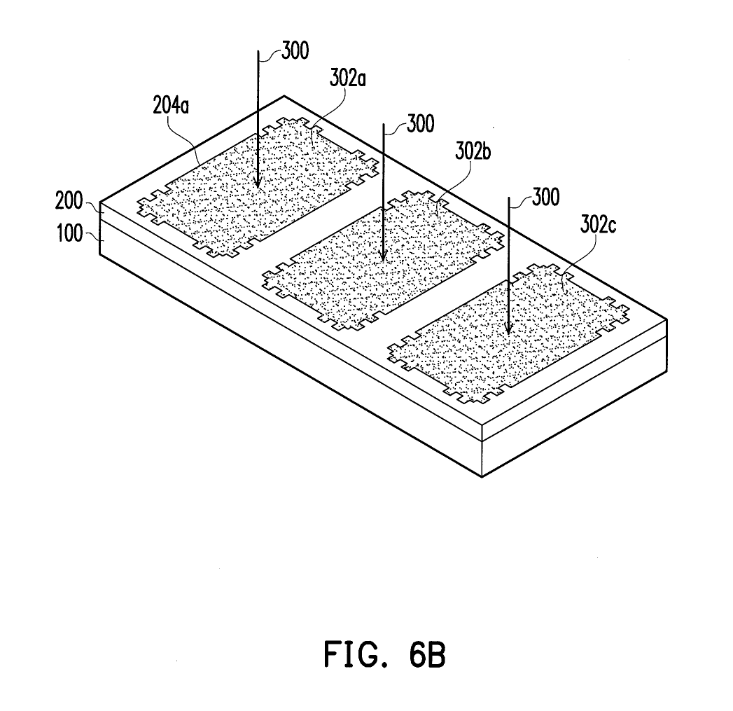

FIG. 6A to FIG. 6B are schematic diagrams illustrating a method of manufacturing a color filter array according to another embodiment of the invention. The embodiment of FIG. 6A to FIG. 6B is similar to the embodiment of FIG. 1A to FIG. 1B, and components identical to those of FIG. 1A and FIG. 1B will be denoted with the same numerals and not repeated herein. Referring to FIG. 6A, in the embodiment, each of the openings 202 of the light shielding structure 200 has a corner portion between the adjacent side walls, the recess patterns 206 are disposed at the corner portion. In details, there is a corner portion 208a between the side wall 204a and the side wall 204c of the opening 202; there is a corner portion 208b between the side wall 204c and the side wall 204b of the opening 202; there is a corner portion 208c between the side wall 204a and the side wall 204d of the opening 202; and there is a corner portion 208d between the side wall 204b and the side wall 204d of the opening 202. The recess patterns 206 are disposed at the corner portions 208a, 208b, 208c and 208d. In other words, the recess patterns 206 in the embodiment are not uniformly arranged on the side walls 204a, 204b, 204c, and 204d of the opening 202. The recess patterns 206 are disposed at the corner portions 208a, 208b, 208c and 208d, and the length, the width and the space of the recess patterns 206 are also the same or similar to the foregoing embodiments.

After forming the light shielding structure 200, as shown in FIG. 6B, an ink-jet printing process 300 is performed to inject color inks 302a, 302b, 302c into the openings 202 of the light shielding structure 200. Similarly, the light shielding structure 200 has the recess patterns 206 disposed at the corner portions 208a, 208b, 208c and 208d, and the length and the width of the recess patterns 206 are specifically defined. Hence, the color inks 302a, 302b, 302c may be drawn into the recess patterns 206 through capillary effect of the recess patterns 206 during the ink jetprinting process 300. In particular, the color inks 302a, 302b, 302c may be pulled toward the edges of the openings 200 through the capillary effect of the recess patterns 206, and thus the height of the liquid surface of each color inks 302a, 302b, 302c in the openings 202 is uniform. Thereafter, a curing process is performed to solidify the color inks 302a, 302b, 302c so as to form a plurality of color filter patterns.

In light of the foregoing, because the at least one side wall of the openings of the light shielding structure has the recess patterns, the color inks in the openings may be drawn into the recess patterns when the color inks are injected into the openings with the ink-jet printing process. In other words, since the color ink in each of the openings is drawn into the recess patterns through capillary effect of the recess patterns during the ink-jet printing process, the height of the liquid surface of the color ink in the opening of the light shielding structure is uniform. Therefore, after the curing process, the formed color filter patterns may have even or flat surfaces. If a display having said color filter array, the display may have good color display quality.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A color filter array, comprising:
a substrate having a plurality of unit regions;
a light shielding structure, disposed on the substrate and having a plurality of openings exposing the unit regions, wherein at least one side wall of each of the openings of the light shielding structure has a plurality of recess patterns; and
a plurality of color filter patterns, respectively disposed in the openings of the light shielding structure.

2. The color filter array as claimed in claim 1, wherein a width W of each of the recess patterns is 0<W≦30 um, and a length L of each of the recess patterns is 0<L≦8 um.

3. The color filter array as claimed in claim 2, wherein a space D between the recess patterns is 0<D≦30 um.

4. The color filter array as claimed in claim 1, wherein each of the openings of the light shielding structure has a plurality of side walls, the all of the side walls have the recess patterns.

5. The color filter array as claimed in claim 1, wherein each of the openings of the light shielding structure has a corner portion between the adjacent side walls, and the recess patterns are disposed at the corner portion.

6. The color filter array as claimed in claim 1, wherein the light shielding structure has a top surface and a bottom surface, and the recess patterns pass though the light shielding structure from the top surface to the bottom surface.

7. The color filter array as claimed in claim 6, wherein the bottom surface faces to the substrate, and the recess patterns expose the substrate.

8. The color filter array as claimed in claim 1, further comprising a light shielding base, disposed on a bottom of the light shielding structure.

9. The color filter array as claimed in claim 8, wherein the light shielding base has a plurality of openings exposing the unit regions, each of the openings of the light shielding base has a side wall, and a width of the light shielding base, which is from the edge of the unit region to the side wall of the opening of the light shielding base, is larger than a width of the light shielding structure, which is from the edge of the unit region to the side wall of the opening of the light shielding structure.

10. The color filter array as claimed in claim 8, wherein the recess patterns expose the light shielding base.

11. A method of manufacturing a color filter array, comprising:
providing a substrate having a plurality of unit regions;
forming a light shielding structure on the substrate, the light shielding structure having a plurality of openings exposing the unit regions, wherein at least one side wall of each of the openings of the light shielding structure has a plurality of recess patterns;
performing an ink jet printing process to inject color inks in the openings of the light shielding structure, wherein the color inks in the openings are drawn into the recess patterns; and
performing a curing process so as to solidify the color inks to form a plurality of color filter patterns.

12. The method as claimed in claim 11, wherein the color inks in the openings are drawn into the recess patterns of the light shielding structure through capillary effect during the ink-jet printing process.

13. The method as claimed in claim 11, wherein a width W of each of the recess patterns is 0<W≦30 um, a length L of each of the recess patterns is 0<L≦8 um, and a space D between the recess patterns is 0<D≦30 um.

14. The method as claimed in claim 11, wherein each of the openings of the light shielding structure has a plurality of side walls, the all of the side walls have the recess patterns.

15. The method as claimed in claim 11, wherein each of the openings of the light shielding structure has a corner portion between the adjacent side walls, the recess patterns are disposed at the corner portion.

16. The method as claimed in claim 11, wherein the light shielding structure has a top surface and a bottom surface, and the recess patterns pass though the light shielding structure from the top surface to the bottom surface to expose the substrate.

17. The method as claimed in claim 11, further comprising a light shielding base, disposed on a bottom of the light shielding structure.

18. The method as claimed in claim 17, wherein the light shielding base and the light shielding structure are formed by performing a half-tone mask process.

19. The method as claimed in claim 17, wherein the light shielding base has a plurality of openings exposing the unit regions, each of the openings of the light shielding base has a side wall, and a width of the light shielding base, which is from the edge of the unit region to the side wall of the opening of the light shielding base, is larger than a width of the light shielding structure, which is from the edge of the unit region to the side wall of the opening of the light shielding structure.

20. The method as claimed in claim 17, wherein the recess patterns expose the light shielding base.
